(19) United States
(12) Patent Application Publication
(10) Pub. No.: US 2021/0003808 A1
(43) Pub. Date: Jan. 7, 2021

(54) LENS MODULE AND ELECTRONIC DEVICE

(71) Applicant: AAC Optics Solutions Pte. Ltd., Singapore city (SG)

(72) Inventor: Chuandong Wei, Shenzhen (CN)

(21) Appl. No.: 16/916,164

(22) Filed: Jun. 30, 2020

(30) Foreign Application Priority Data
Jul. 5, 2019 (CN) PCT/CN2019/094883

(51) Int. Cl. G02B 7/02; G02B 13/18

(52) U.S. Cl. CPC G02B 7/021; G02B 13/18; G02B 7/026

(57) ABSTRACT

The present disclosure provides a lens module and an electronic device comprising a lens barrel, an optical component and a pressing ring. The pressing ring comprises a pressing structure and a supporting structure connected to the pressing structure, the pressing structure comprises an abutting surface and a first tapered surface. The supporting structure comprises a second tapered surface, both center lines of the first and the second tapered surface coincide with the center line of the light-through hole, and the taper of the first tapered surface is equal to that of the second tapered surface. An angle formed by the generatrixes of the first and second tapered surfaces and the center line of the light-through hole is larger than an angle formed by the center line of the light-through hole and the light in maximum of field of view.

### TECHNICAL FIELD

The present disclosure relates to a field of optical imaging technology, in particular to a lens module and an electronic device.

### BACKGROUND

Components of optical lens module are widely used in consumer digital products, such as mobile phones, laptops, toys, industrial detection, car cameras and medical fields. With development of imaging technology and widespread use of electronic products with camera functions, components of optical lens module are widely used in various fields of life.

Under the circumstance that shape and size of the lens module are limited, there is certain requirement on thickness of bottom of the lens barrel when designing the bottom, and when light reaches the inner wall of the bottom of the lens barrel and then reflected to an imaging surface, stray light will be generated, thus reducing the quality of photos taken by the lens module.

Therefore, it is necessary to provide a lens module to solve the above technical problems.

### SUMMARY

The purpose of the present disclosure is to provide a lens module, so as to solve the problem that the lens module generates stray light and thus the imaging quality is reduced.

The technical scheme of the present disclosure is as follows.

A lens module, comprising a lens barrel having a receiving space, an optical component received in the receiving space, and a pressing ring abutting against the optical component from an image side, wherein, the lens barrel comprises a first barrel wall with a light-through hole and a second barrel wall bent and extending from the first barrel wall;

the pressing ring comprises a pressing structure, and a supporting structure connected to the pressing structure from the image side; the pressing structure comprises an abutting surface abutting against the optical component from the image side and a first tapered surface connected to the abutting surface and facing the receiving space; the supporting structure comprises a second tapered surface facing the receiving space, both a center line of the first tapered surface and a center line of the second tapered surface coincide with a center line of the light-through hole, and a taper of the first tapered surface is equal to that of the second tapered surface; and

an angle formed by generatrixes of the first and the second tapered surfaces and the center line of the light-through hole is larger than an angle formed by the center line of the light-through hole and light in maximum of field of view.

As an improvement, the first tapered surface is connected to the second tapered surface.

As an improvement, the first tapered surface and the second tapered surface are spaced apart from each other.

As an improvement, the lens barrel further comprises a bottom wall connected to the second barrel wall and disposed opposite to the first barrel wall in a direction parallel to the center line, and the supporting structure extends from the bottom wall of the lens barrel in a direction away from the optical component.

As an improvement, the optical component comprises a plurality of lenses, and the abutting surface abuts against a lens of the plurality of lens closest to the image side.

As an improvement, the second barrel wall comprises an inner wall that encloses to form the receiving space; and the abutting surface, an image side surface of the lens abutting against the abutting surface and the inner wall enclose to form a first glue groove.

As an improvement, the second barrel wall comprises an inner wall that encloses to form the receiving space; the pressing structure further comprises a first outer surface disposed opposite to the first tapered surface in a direction perpendicular to the center line; the supporting structure further comprises a second outer surface disposed opposite to the second tapered surface in the direction perpendicular to the center line; and the first outer surface, the second outer surface and the inner wall enclose to form a second glue groove.

As an improvement, the second barrel wall comprises an inner wall that encloses to form the receiving space, and the inner wall, the pressing structure and the supporting structure enclose to form a second glue groove.

As an improvement, the second barrel wall comprises an inner wall that encloses to form the receiving space; the pressing structure further comprises a bottom surface disposed opposite to the abutting surface in a direction parallel to the center line; and the bottom surface and the inner wall enclose to form a second glue groove. The present disclosure also provides an electronic device including the lens module as mentioned above.

The beneficial effects of the present disclosure lie in that: the lens module comprises a lens barrel having a receiving space, an optical component received in the receiving space, and a pressing ring abutting against the optical component from an image side, where, the lens barrel comprises a first barrel wall with a light-through hole and a second barrel wall bent and extending from the first barrel wall; the pressing ring comprises a pressing structure, and a supporting structure connected to the pressing structure from the image side; the pressing structure comprises an abutting surface abutting against the optical component from the image side and a first tapered surface connected to the abutting surface and facing the receiving space; the supporting structure comprises a second tapered surface facing the receiving space, both a center line of the first tapered surface and a center line of the second tapered surface coincide with a center line of the light-through hole, and a taper of the first tapered surface is equal to that of the second tapered surface; an angle formed by generatrixes of the first and the second tapered surfaces and the center line of the light-through hole is larger than an angle formed by the center line of the light-through hole and light in maximum of field of view. As the angle formed by the first and second tapered surfaces of the pressing ring and the center line of the light-through hole is larger than the angle between the center line of the clear hole and the light in maximum of field of view, when the light in maximum of field of view enters the lens module from the light-through hole, passes through the optical component and reaches the bottom of the lens module, the light in maximum of field of view reaching the bottom of the lens barrel will be emitted from the bottom of the first tapered surface and the second tapered surface of the pressing ring, instead of being reflected to the imaging surface, thus avoiding generation of stray light and improving the imaging quality.

The electronic device provided by the present disclosure comprises the above-mentioned lens module, and thus has all the beneficial effects of the lens module, which will not be repeated here.

### BRIEF DESCRIPTION OF THE DRAWINGS

FIG. 1 is a schematic view illustrating a cross-sectional structure of the lens module according to Embodiment 1 of the present disclosure;

FIG. 2 is a schematic view illustrating a partial exploded structure of the lens module in Embodiment 1 of the present disclosure;

FIG. 3 is a schematic view illustrating a cross-sectional structure of the lens module according to Embodiment 2 of the present disclosure;

FIG. 4 is a schematic view illustrating a partial exploded structure of the lens module in Embodiment 2 of the present disclosure;

FIG. 5 is a schematic view illustrating a cross-sectional structure of the lens module according to Embodiment 3 of the present disclosure; and

FIG. 6 is a schematic view illustrating a partial exploded structure of the lens module in Embodiment 3 of the present disclosure.

### DETAILED DESCRIPTION

The present disclosure will be further described below with reference to the drawings and embodiments.

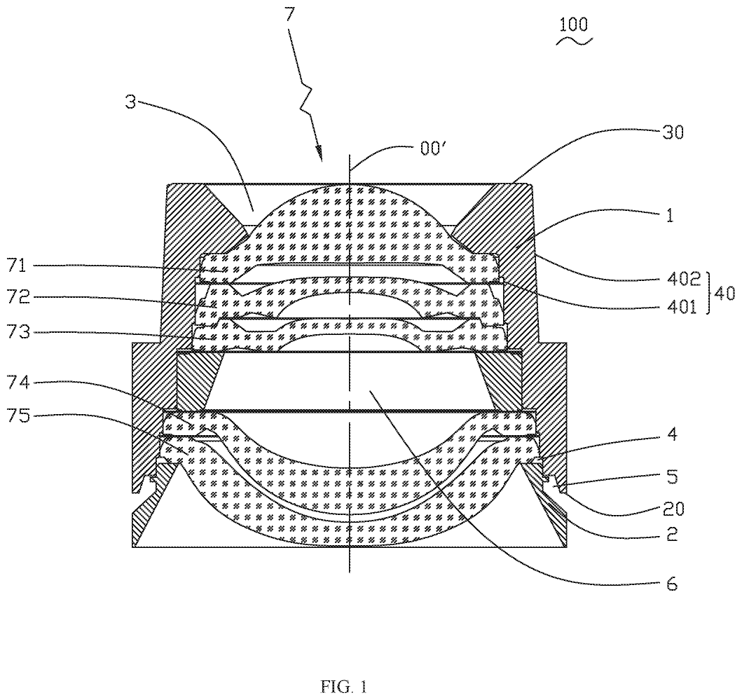

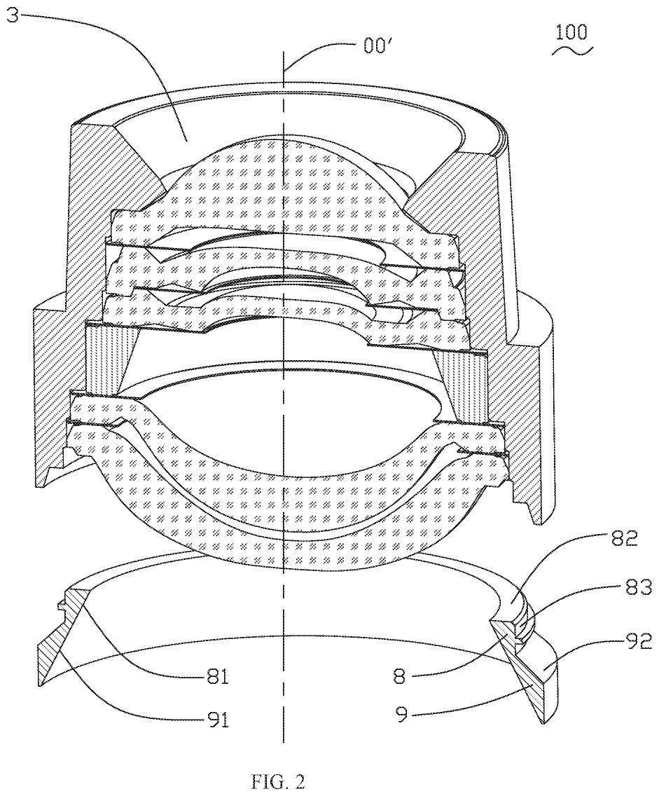

Referring to FIGS. 1-2, Embodiment 1 of the present disclosure provides a lens module 100 comprising a lens barrel 1 having a receiving space 6, an optical component 7 received in the receiving space 6, and a pressing ring 2 abutting against the component 7 from an image side. The lens barrel 1 comprises a first barrel wall 30 having a light-through hole 3 and a second barrel wall 40 bent and extending from the first barrel wall 30; the optical component 7 comprises five lenses, and the optical component 7 comprises a first lens 71, a second lens 72, a third layer 73, a fourth lens 74 and a fifth lens 75 stacked in sequence from an object side to the image side in a direction parallel to a center line 00′ of the light-through hole 3.

The pressing ring 2 comprises a pressing structure 8 and a supporting structure 9 connected to the pressing structure 8 from the image side. The pressing structure 8 comprises an abutting surface 82 abutting against an image side surface of the fifth lens 75 from the image side, and a first tapered surface 81 connected to the abutting surface 82 and facing the receiving space 6. The supporting structure comprises a second tapered surface 91 facing the receiving space 6, both a center line 00′ of the first tapered surface 81 and a center line 00′ of the second tapered surface 91 coincide with a center line 00′ of the light-through hole 3, and a taper of the first tapered surface 81 is equal to that of the second tapered surface 91.

An angle formed by generatrixes of the first and the second tapered surfaces 81, 91 and the center line 00′ of the light-through hole 3 is larger than an angle formed by the center line 00′ and the light in maximum of field of view. As an angle formed by the first and the second tapered surfaces 81, 91 of the pressing ring 2 and the center line 00′ is larger than an angle formed by the center line 00′ and the light in maximum of field of view, when the light in maximum of field of view enters the lens module 100 from the light-through hole 3, passes through the optical component 7, and reaches the bottom of the lens module 100, the light in maximum of field of view reaching the bottom of the lens barrel will be emitted from the bottom of the first tapered surface 81 and the second tapered surface 91 of the pressing ring 2, instead of being reflected to the imaging surface, thus avoiding generation of stray light and improving the imaging quality.

Referring to FIGS. 1-2, in an embodiment, the first tapered surface 81 is connected to the second tapered surface 91. In this arrangement, the production and assembly of the pressing ring 2 is facilitated.

Referring to FIGS. 1-2, in an embodiment, the lens barrel 1 further comprises a bottom wall connected to the second barrel wall 40 and disposed opposite to the first barrel wall 30 in a direction parallel to the center line 00′ of the light-through hole 3, and the supporting structure 9 extends from the bottom wall 20 of the lens barrel 1 in a direction away from the optical component 7. This structure can prevent light from being reflected to the imaging surface to generate stray light without affecting the overall size of the lens module 100, thus improving the imaging quality.

Referring to FIGS. 1-2, in an embodiment, the second barrel wall 40 comprises an inner wall 401 that encloses to form the receiving space 6. An abutting surface 82, a lens abutting against the abutting surface 82 (that is, an imaging surface of the fifth lens 75) and the inner wall 401 enclose to form a first glue groove 4. In this arrangement, the first glue groove 4 is used to accommodate glue, and the glue connects the fifth lens 75 to the inner wall 401. With the glue of the first glue groove 4, the optical component 7 is more firm. That is, the overall stability of the lens module 100 is improved.

Referring to FIGS. 1-2, in an embodiment, the pressing structure 8 further comprises a first outer surface 83 disposed opposite to the first tapered surface 81 in a direction perpendicular to the center line 00′ of the light-through hole 3. The supporting structure 9 further comprises a second outer surface 92 disposed opposite to the second tapered surface 91 in the direction perpendicular to the center line 00′ of the light-through hole 3. The first outer surface 83, the second outer surface 92 and the inner wall 401 enclose to form a second glue groove 5. In this arrangement, the second glue groove 5 is used to accommodate glue, and with the glue of the second glue groove 5, the pressing ring 2 is more tightly connected to the optical component 7, such that the lens module 300 is more firm. That is, the overall stability of the lens module 100 is improved. To further describe in details, the pressing structure 8 is also provided with a circumferential convex structure on an outer periphery of the first outer surface 83, and the convex structure is located in the second glue groove 5. With this arrangement, the contact area between glue in the glue groove 5 and the pressing ring 2 is increased and the overall stability of the lens module 100 is further improved.

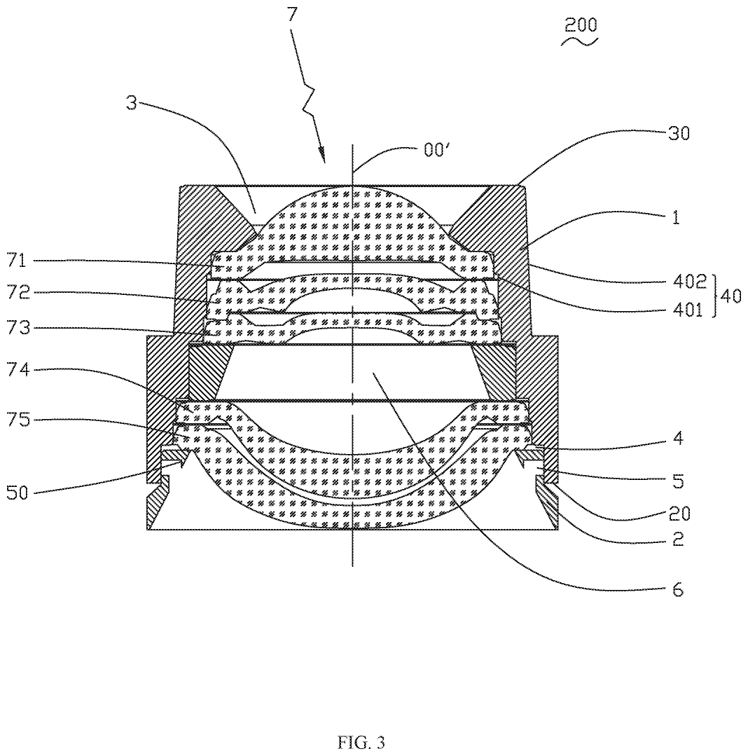

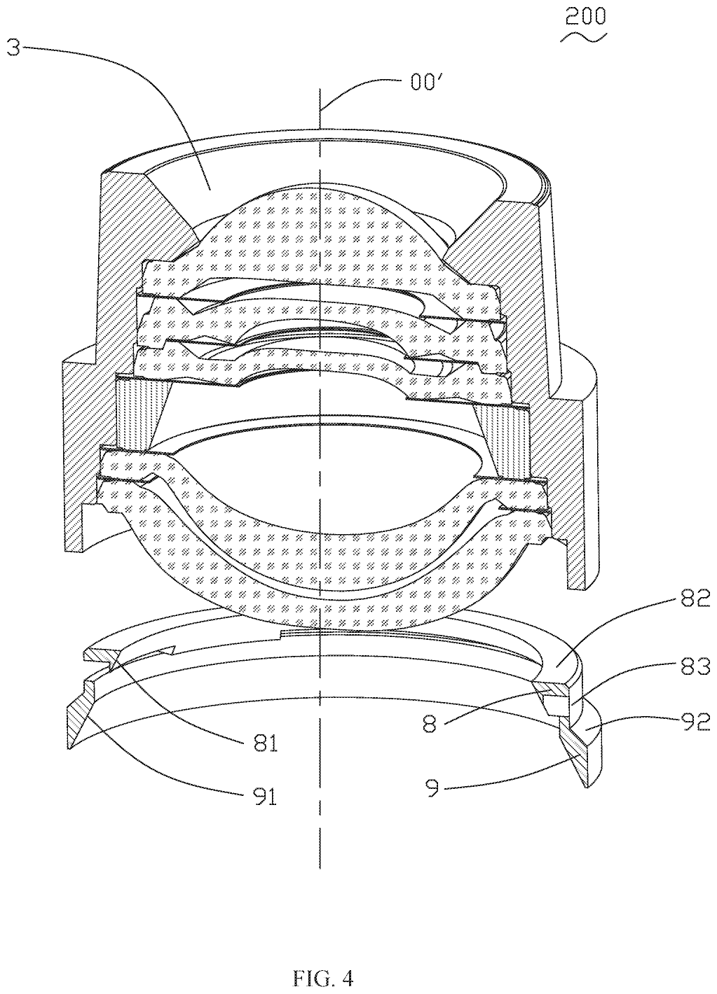

Referring to FIGS. 3-4, Embodiment 2 of the present disclosure provides a lens module 200. Except for the pressing ring 2, the remaining components of the lens module 200 have structures same as those in Embodiment 1. Thus the description for those components will not be repeated here, but only the differences between the pressing ring 2 and Embodiment 1 will described below.

The first tapered surface 81 and the second tapered surface 91 of the pressing ring 2 are spaced apart from each other. In other words, an interval is formed between the pressing structure 8 and the supporting structure 9 in a direction parallel to the center line 00′ of the light passing hole 3. The pressing structure 8, the supporting structure 9 and the inner wall 401 enclose to form a second glue groove 5. With this arrangement, the second glue groove 5 is used to accommodate glue, and the first tapered surface 81 extends toward the image side. In other words, an edge of the upper wall surface of the second glue groove 5 close to the center line 00′ of the light-through hole 3 extends toward the image side to form a convex wall 50, which prevents the glue from overflowing; with the glue of the second glue groove 5, the pressing ring 2 is more tightly connected to the optical component 7 such that the lens module 200 is more firm. That is, the overall stability of the lens module 200 is improved.

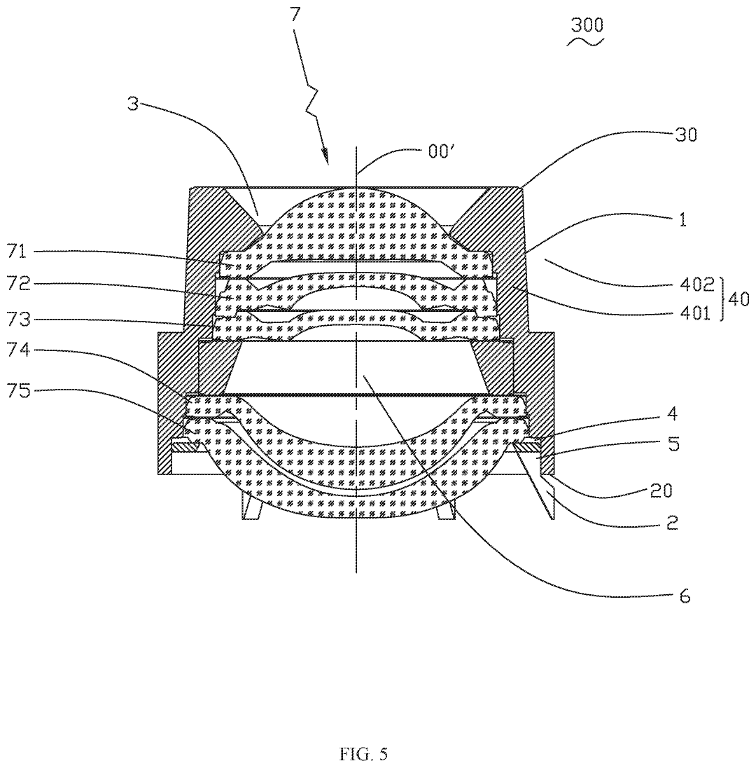

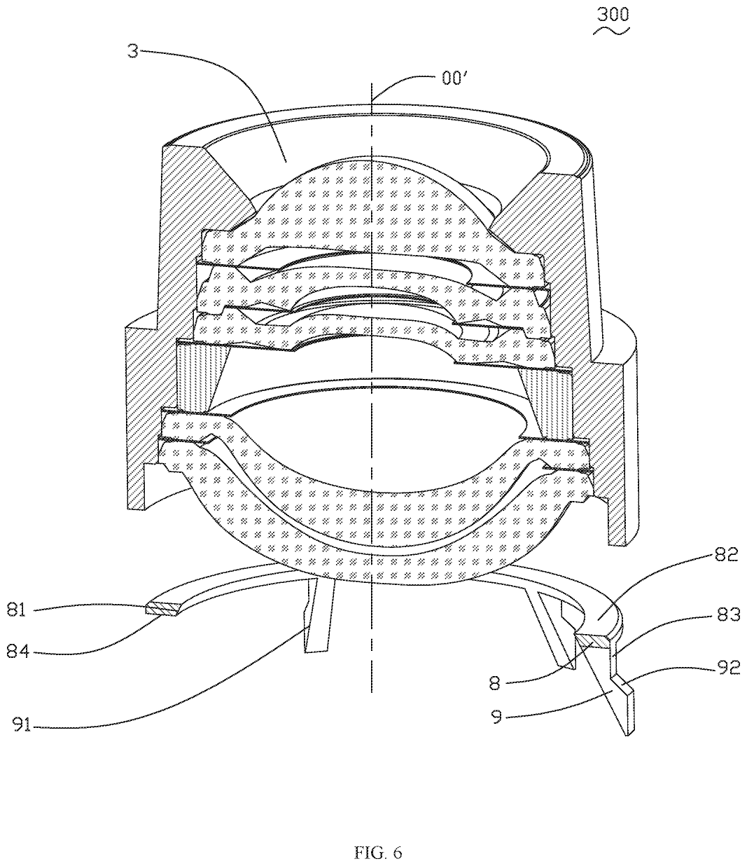

Referring to FIGS. 5-6, Embodiment 3 of the present disclosure provides a lens module 300. Except for the pressing ring 2, the remaining components of the lens module 300 have the same structure as those in Embodiment 1. Thus the description for those components will not be repeated here, but only the differences between the pressing ring 2 and Embodiment 1 will described below.

The first tapered surface 81 of the pressing ring 2 is connected to the second tapered surface 91. The pressing structure 8 further comprises a bottom surface 84 disposed opposite to the abutting surface 82 in the direction parallel to the center line 00′ of the light-through hole 3. The bottom surface 84 and the inner wall 401 enclose to form a second glue groove 5. With this arrangement, the second glue groove 5 is used to accommodate glue; and with the glue of the second glue groove 5 the pressing ring 2 is more tightly connected to the optical component 7, such that the lens module 300 is more firm. That is, the overall stability of the lens module 300 is improved.

The present disclosure also provides an electronic device, which comprises the above-mentioned lens module 100. The electronic device provided by the present disclosure comprises the above-mentioned lens module, and thus has all the beneficial effects of the lens module, which will not be repeated here.

The above are only the embodiments of the present disclosure. It should be noted that, improvements can be made by those skill in the art without departing from the creative concept of the present disclosure, but all of these belong to the protection range of the present disclosure.

What is claimed is:

1. A lens module comprising: a lens barrel having a receiving space, an optical component received in the receiving space, and a pressing ring abutting against the optical component from an image side, wherein,
the lens barrel comprises a first barrel wall with a light-through hole and a second barrel wall bent and extending from the first barrel wall;
the pressing ring comprises a pressing structure, and a supporting structure connected to the pressing structure from the image side; the pressing structure comprises an abutting surface abutting against the optical component from the image side and a first tapered surface connected to the abutting surface and facing the receiving space; the supporting structure comprises a second tapered surface facing the receiving space, both a center line of the first tapered surface and a center line of the second tapered surface coincide with a center line of the light-through hole, and a taper of the first tapered surface is equal to that of the second tapered surface; and
an angle formed by generatrixes of the first and the second tapered surfaces and the center line of the light-through hole is larger than an angle formed by the center line of the light-through hole and light in maximum of field of view.

2. The lens module according to claim 1, wherein the first tapered surface is connected to the second tapered surface.

3. The lens module according to claim 1, wherein the first tapered surface and the second tapered surface are spaced apart from each other.

4. The lens module according to claim 1, wherein the lens barrel further comprises a bottom wall connected to the second barrel wall and disposed opposite to the first barrel wall in a direction parallel to the center line, and the supporting structure extends from the bottom wall of the lens barrel in a direction away from the optical component.

5. The lens module according to claim 1, wherein the optical component comprises a plurality of lenses, and the abutting surface abuts against a lens of the plurality of lens closest to the image side.

6. The lens module according to claim 5, wherein the second barrel wall comprises an inner wall that encloses to form the receiving space; and the abutting surface, an image side surface of the lens abutting against the abutting surface and the inner wall enclose to form a first glue groove.

7. The lens module according to claim 2, wherein the second barrel wall comprises an inner wall that encloses to form the receiving space; the pressing structure further comprises a first outer surface disposed opposite to the first tapered surface in a direction perpendicular to the center line; the supporting structure further comprises a second outer surface disposed opposite to the second tapered surface in the direction perpendicular to the center line; and the first outer surface, the second outer surface and the inner wall enclose to form a second glue groove.

8. The lens module according to claim 3, wherein the second barrel wall comprises an inner wall that encloses to form the receiving space, and the inner wall, the pressing structure and the supporting structure enclose to form a second glue groove.

9. The lens module according to claim 2, wherein the second barrel wall comprises an inner wall that encloses to form the receiving space; the pressing structure further comprises a bottom surface disposed opposite to the abutting surface in a direction parallel to the center line; and the bottom surface and the inner wall enclose to form a second glue groove.

10. The lens module according to claim 2, wherein the lens barrel further comprises a bottom wall connected to the second barrel wall and disposed opposite to the first barrel wall in a direction parallel to the center line, and the supporting structure extends from the bottom wall of the lens barrel in a direction away from the optical component.

11. An electronic device, comprising a lens module, wherein, the lens module comprises: a lens barrel having a receiving space, an optical component received in the receiving space, and a pressing ring abutting against the optical component from an image side, wherein,
the lens barrel comprises a first barrel wall with a light-through hole and a second barrel wall bent and extending from the first barrel wall;
the pressing ring comprises a pressing structure, and a supporting structure connected to the pressing structure from the image side; the pressing structure comprises an abutting surface abutting against the optical component from the image side and a first tapered surface connected to the abutting surface and facing the receiving space; the supporting structure comprises a second tapered surface facing the receiving space, both a center line of the first tapered surface and a center line of the second tapered surface coincide with a center line of the light-through hole, and a taper of the first tapered surface is equal to that of the second tapered surface; and
an angle formed by generatrixes of the first and the second tapered surfaces and the center line of the light-through hole is larger than an angle formed by the center line of the light-through hole and light in maximum of field of view.

12. The electronic device according to claim 11, wherein the first tapered surface is connected to the second tapered surface.

13. The electronic device according to claim 11, wherein the first tapered surface and the second tapered surface are spaced apart from each other.

14. The electronic device according to claim 11, wherein the lens barrel further comprises a bottom wall connected to the second barrel wall and disposed opposite to the first barrel wall in a direction parallel to the center line, and the supporting structure extends from the bottom wall of the lens barrel in a direction away from the optical component.

15. The electronic device according to claim 11, wherein the optical component comprises a plurality of lenses, and the abutting surface abuts against a lens of the plurality of lens closest to the image side.

16. The electronic device according to claim 15, wherein the second barrel wall comprises an inner wall that encloses to form the receiving space; and the abutting surface, an image side surface of the lens abutting against the abutting surface and the inner wall enclose to form a first glue groove.

17. The electronic device according to claim 12, wherein the second barrel wall comprises an inner wall that encloses to form the receiving space; the pressing structure further comprises a first outer surface disposed opposite to the first tapered surface in a direction perpendicular to the center line; the supporting structure further comprises a second outer surface disposed opposite to the second tapered surface in the direction perpendicular to the center line; and the first outer surface, the second outer surface and the inner wall enclose to form a second glue groove.

18. The lens module according to claim 13, wherein the second barrel wall comprises an inner wall that encloses to form the receiving space, and the inner wall, the pressing structure and the supporting structure enclose to form a second glue groove.

19. The lens module according to claim 12, wherein the second barrel wall comprises an inner wall that encloses to form the receiving space; the pressing structure further comprises a bottom surface disposed opposite to the abutting surface in a direction parallel to the center line; and the bottom surface and the inner wall enclose to form a second glue groove.

20. The lens module according to claim 12, wherein the lens barrel further comprises a bottom wall connected to the second barrel wall and disposed opposite to the first barrel wall in a direction parallel to the center line, and the supporting structure extends from the bottom wall of the lens barrel in a direction away from the optical component.
